(19) United States
(12) Patent Application Publication
(10) Pub. No.: US 2005/0043497 A1
(43) Pub. Date: Feb. 24, 2005

(54) Catalyst system and its use in a polymerization process

(76) Inventors: David Edward Gindelberger, Houston, TX (US); David H. McConville, Houston, TX (US)

Correspondence Address: Univation Technologies, LLC, Suite 1950, 5555 San Felipe, Houston, TX, 77056, US

(21) Appl. No.: 10/688,870

(22) Filed: Oct. 17, 2003

Related U.S. Application Data
(62) Division of application No. 09/617,663, filed on Jul. 17, 2000, now abandoned.

(51) Int. Cl. C08F 4/04

(52) U.S. Cl. 526/219

(57) ABSTRACT

Disclosed is a catalyst system including a phenoxide transition metal catalyst compound and a Lewis acid containing activator, a supported catalyst system thereof, a method of preparing the catalyst system and a process for polymerizing olefin(s) utilizing same.

### STATEMENT OF RELATED APPLICATIONS

The present application is a Divisional Application of, and claims priority to U.S. Ser. No. 09/617,663 filed Jul. 17, 2000, now issued as U.S. Pat. No. ______.

### FIELD OF THE INVENTION

The present invention relates to a catalyst system including a phenoxide transition metal compound and a Lewis acid aluminum containing activator and to its use in the polymerization of olefin(s).

### BACKGROUND OF THE INVENTION

Anionic, multidentate heteroatom ligands have received attention as metallocene-type polyolefin catalysts (metallocene being cyclopentadienyl based transition metal catalysts). These metallocene-type catalyst systems may provide product and process opportunities beyond the capability of typical metallocene catalysts, and may also prove to be more economical to synthesize.

Notable classes of bidentate anionic ligands which form active polymerization catalysts include N—N⁻ and N—O⁻ ligand sets. Examples of these types of new catalysts include amidopyridines (Kempe, R., “Aminopyridinato Ligands—New Directions and Limitations”, 80^{th} Canadian Society for Chemistry Meeting, Windsor, Ontario, Canada, Jun. 1-4, 1997. Kempe, R. et al, Inorg. Chem. 1996 vol 35 6742.) Likewise, recent reports by Jordan et al. of polyolefin catalysts based on hydroxyquinolines (Bei, X.; Swenson, D. C.; Jordan, R. F., Organometallics 1997, 16, 3282) have been interesting even though the catalytic activities of Jordan's hydroxyquinoline catalysts is low.

European Patent Application EP 0 803 520 A1 discloses polymerization catalysts containing beta-diketiminate ligands. Other new olefin polymerization catalysts include U.S. Pat. No. 4,057,565, which discloses 2-dialkylaminobenzyl and 2-dialkylaminomethylphenyl derivatives of selected transition metals, and WO 96/08498, which discloses Group 4 metal complexes containing a bridged non-aromatic, anionic dienyl ligand group.

U.S. Pat. No. 5,318,935 discloses catalyst systems including certain bridged and unbridged amido transition metal compounds of the Group IVB metals for the production of high molecular weight polyolefins and in particular, high molecular weight isotactic polypropylene.

U.S. Pat. No. 5,637,660 discloses bidentate pyridine based transition metal catalysts.

Grubbs et al in Organometallics, Vol 17, 1988 page 3149-3151 disclose that nickel (II) salicylaldiminato complexes combined with B(C₆F₅)₃ polymerized ethylene.

Ethylenebis(salicylideneiminato)zirconium dichloride combined with methyl alumoxane deposited on a support and unsupported versions were used to polymerize ethylene by Repo et al in Macromolecules 1997, 30, 171-175.

EP 0 241 560 A1 discloses alkoxide ligands in transition metal catalyst systems.

EP 0 874 005 A1 discloses phenoxide compounds with an imine substituent for use as a polymerization catalyst.

Polymerization catalyst compounds, including those containing anionic, multidentate heteroatom ligands, are typically activated to yield compounds having a vacant coordination site that will coordinate, insert, and polymerize olefins. Group 13 based Lewis acids having three fluorinated aryl substituents are known to be capable of activating transition metal compounds into olefin polymerization catalysts. Trisperfluorophenylborane, for example, is demonstrated in EP 0 425 697 A and EP 0 520 732 A to be capable of abstracting a ligand for cyclopentadienyl derivatives of transition metals, while providing a stabilizing, compatible noncoordinating anion. See also, Marks, et al, J. Am. Chem. Soc. 1991, 113, 3623-3625. The term “noncoordinating anion” is now accepted terminology in the field of olefin polymerization, both by coordination or insertion polymerization and carbocationic polymerization. See for example, EP 0 277 004 A, U.S. Pat. Nos. 5,198,401 and 5,668,324, and Baird, Michael C., et al, J. Am. Chem. Soc. 1994, 116, 6435-6436. These noncoordinating anions are described to function as electronic stabilizing cocatalysts, or counterions, for cationic metallocene complexes which are active for olefin polymerization. The term noncoordinating anion as used herein applies to truly noncoordinating anions and coordinating anions that are at most weakly coordinated to the cationic complex so as to be labile to replacement by olefinically or acetylenically unsaturated monomers at the insertion site. The synthesis of Group 13-based compounds derived from trisperfluorophenylborane are described in EP 0 694 548 A. These Group 13-based compounds are said to be represented by the formula M(C₆F₅)₃ and are prepared by reacting the trisperfluorophenylborane with dialkyl or trialkyl Group 13-based compounds at a molar ratio of “basically 1:1” so as to avoid mixed products, those including the type represented by the formula M(C₆F₅)ₙR₃₋ₙ, where n=1 or 2. Utility for the tris-aryl aluminum compounds in Ziegler-Natta olefin polymerization is suggested.

Perfluorophenylaluminum(toluene) has been characterized via X-ray crystallography. See, Hair, G. S., Cowley, A. H., Jones, R. A., McBurnett, B. G.; Voigt, A., J. Am. Chem. Soc., 1999, 121, 4922. Arene coordination to the aluminum complex demonstrates the Lewis acidity of the aluminum center. However, perfluorophenyl-aluminum complexes have been implicated as possible deactivation sources in olefin polymerizations which utilize Trityl⁺ B(C₆F₅)₄⁻/alkylaluminum combinations to activate the catalysts. See, Bochmann, M.; Sarsfield, M. J.; Organometallics 1998, 17, 5908. Bochmann and Sarsfield have shown that Cp₂ZrMe₂ reacts with Al(C₆F₅)₃0.5(toluene) with transfer of the C₆F₅— moiety forming metallocene pentafluorophenyl complexes. These complexes were reported having very low activity compared to the corresponding metallocene dimethyl complexes when activated with B(C₆F₅)₃ or Trityl⁺ B(C₆F₅)₄⁻.

Usually, non-coordinating anions are used as catalyst activators in solution polymerization processes. This is because the supporting of non-coordinating anion activators typically results in a significant loss of activity. Supported non-coordinating anions derived from trisperfluorophenyl boron are described in U.S. Pat. No. 5,427,991. Trisperfluorophenyl boron is shown to be capable of reacting with coupling groups bound to silica through hydroxyl groups to form support bound anionic activators capable of activating transition metal catalyst compounds by protonation. U.S. Pat. Nos. 5,643,847 and 5,972,823 discuss the reaction of Group 13 Lewis acid compounds with metal oxides such as silica and illustrates the reaction of trisperfluorophenyl boron with silanol groups (the hydroxyl groups of silicon) resulting in bound anions capable of protonating transition metal organometallic catalyst compounds to form catalytically active cations counter-balanced by the bound anions.

Immobilized Group IIIA Lewis acid catalysts suitable for carbocationic polymerizations are described in U.S. Pat. No. 5,288,677. These Group IIIA Lewis acids are said to have the general formula RₙMX₃₋ₙ where M is a Group IIIA metal, R is a monovalent hydrocarbon radical consisting of C₁ to C₁₂ alkyl, aryl, alkylaryl, arylalkyl and cycloalkyl radicals, n=0 to 3, and X is halogen. Listed Lewis acids include aluminum trichloride, trialkyl aluminums, and alkylaluminum halides. Immobilization is accomplished by reacting these Lewis acids with hydroxyl, halide, amine, alkoxy, secondary alkyl amine, and other groups, where the groups are structurally incorporated in a polymeric chain. James C. W. Chien, Jour. Poly. Sci.: Pt A: Poly. Chem, Vol. 29, 1603-1607 (1991), describes the olefin polymerization utility of methylalumoxane (MAO) reacted with SiO₂ and zirconocenes and describes a covalent bonding of the aluminum atom to the silica through an oxygen atom in the surface hydroxyl groups of the silica.

While these catalyst compounds and activators have been described in the art, there is still a need for an improved catalyst system. In addition, there is a need for improvements in supported catalyst systems typically used in the gas phase and the slurry polymerization of olefins, where such supported catalysts are required to meet the demanding criteria of industrial processes.

### SUMMARY OF THE INVENTION

This invention provides for a catalyst system, methods of making a catalyst system, and for its use in polymerization processes.

In one embodiment, the invention is directed to a catalyst system including at least one heteroatom substituted phenoxide ligated Group 3 to 10 transition metal or lanthanide metal catalyst compound, wherein the metal is bound to the oxygen of the phenoxide group, and a Lewis acid activator, preferably a Lewis acid alumoxane containing activator, and to the use of the catalyst system use in the polymerization of olefin(s).

In another embodiment, the invention is directed to a method for supporting the heteroatom substituted phenoxide ligated Group 3 to 10 transition metal or lanthanide metal catalyst compound based catalyst system, and to the supported catalyst system itself.

In another embodiment, the invention is directed to a process for polymerizing olefin(s), particularly in a gas phase or slurry phase process, utilizing any one of the catalyst systems or supported catalyst systems described above.

In another embodiment, the invention is directed to a method of making a supported catalyst systems described above.

### DETAILED DESCRIPTION OF THE INVENTION

Introduction

It has been found that catalyst systems including phenoxide complexes of transition metals and a Lewis acid aluminum containing activator exhibit commercially acceptable productivity with excellent operability. In addition, the catalyst system of the invention is supportable on a support material, preferably for use in a slurry or gas phase polymerization process.

Phenoxide Transition Metal Catalyst Compounds and Catalyst Systems

This invention relates to a olefin polymerization catalyst system which includes one or more phenoxide complexes of transition metals and a Lewis acid containing activator, preferably a Lewis acid aluminum containing activator. Generally, the phenoxide transition metal complex is a heteroatom substituted phenoxide ligated Group 3 to 10 transition metal or lanthanide metal compound wherein the metal is bound to the oxygen of the phenoxide group.

The phenoxide transition metal catalyst compounds of the invention may be represented by formula I or II below: 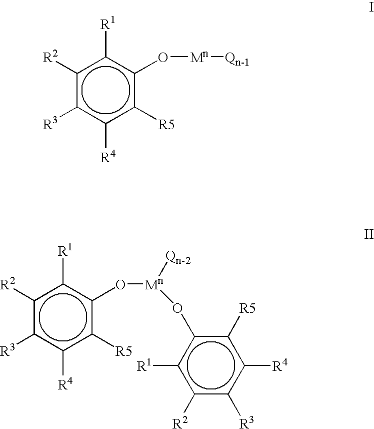
wherein R¹ is hydrogen or a C₄ to C₁₀₀ group, preferably a tertiary alkyl group, preferably a C₄ to C₂₀ alkyl group, preferably a C₄ to C₂₀ tertiary alkyl group, preferably a neutral C₄ to C₁₀₀ group and may or may not also be bound to M;
at least one of R² to R⁵ is a heteroatom containing group, the rest of R² to R⁵ are independently hydrogen or a C₁ to C₁₀₀ group, preferably a C₄ to C₂₀ alkyl group, preferred examples of which include butyl, isobutyl, t-butyl, pentyl, hexyl, heptyl, isohexyl, octyl, isooctyl, decyl, nonyl, dodecyl, and any of R² to R⁵ also may or may not be bound to M;
Each R¹ to R⁵ group may be independently substituted or unsubstituted with other atoms, including heteroatoms or heteroatom containing group(s);
O is oxygen;
M is a Group 3 to Group 10 transition metal or lanthanide metal, preferably a Group 4 metal, preferably M is Ti, Zr or Hf;
n is the valence state of the metal M, preferably 2, 3, 4, or 5; and
Q is, and each Q may be independently be, an alkyl, halogen, benzyl, amide, carboxylate, carbamate, thiolate, hydride or alkoxide group, or a bond to an R group containing a heteroatom which may be any of R¹ to R⁵.

A heteroatom containing group may be any heteroatom or a heteroatom bound to carbon, silicon or another heteroatom. Preferred heteroatoms include boron, aluminum, silicon, nitrogen, phosphorus, arsenic, tin, lead, antimony, oxygen, selenium, tellurium. Particularly preferred heteroatoms include nitrogen, oxygen, phosphorus, and sulfur. Even more particularly preferred heteroatoms include nitrogen and oxygen. The heteroatom itself may be directly bound to the phenoxide ring or it may be bound to another atom or atoms that are bound to the phenoxide ring. The heteroatom containing group may contain one or more of the same or different heteroatoms. Preferred heteroatom containing groups include imines, amines, oxides, phosphines, ethers, ketones, oxoazolines heterocyclics, oxazolines, thioethers, and the like. Particularly preferred heteroatom containing groups include imines. Any two adjacent R groups may form a ring structure, preferably a 5 or 6 membered ring. Likewise the R groups may form multi-ring structures. In one embodiment any two or more R groups do not form a 5 membered ring.

In a preferred embodiment the heteroatom substituted phenoxide transition metal compound is an iminophenoxide Group 4 transition metal compound, and more preferably an iminophenoxidezirconium compound.

Preferred catalyst systems of this invention include those comprising catalysts represented by the following structures. 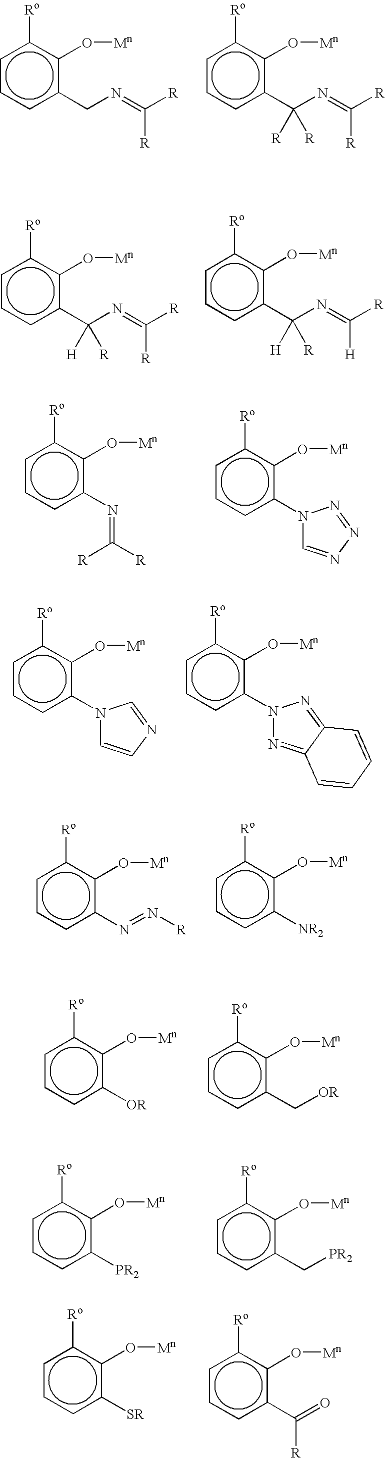 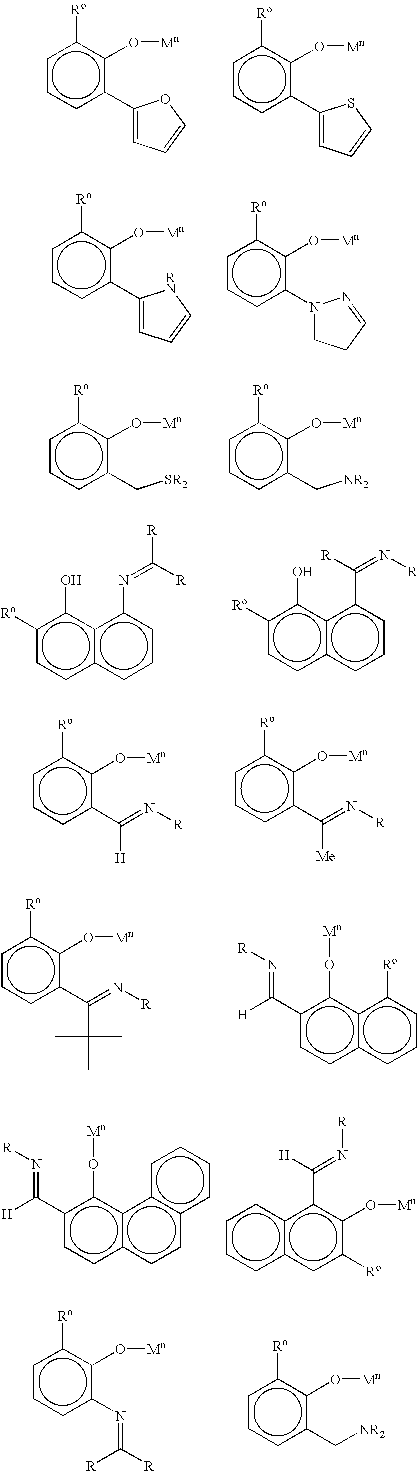 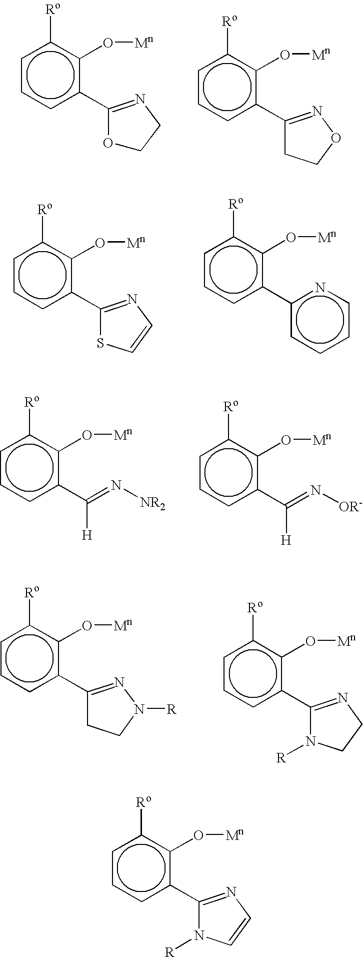
wherein the R⁵ of Formula I may be an aldimino, ketimino, alkoxy, α-alkoxymethyl, thioalkoxy, α-thioalkoxymethyl, amino, α-aminomethyl, azo, phosphino, α-phosphinomethyl, keto, or cyclic substituents such as pyrrole, furan, thiophene, imidazole, pyrazole, tetrazole, oxazoline, isoazole, thiazole.
R^{o} is a tertiary alkyl or silyl group, such as —CMe₃, —CMe₂Et, CEt₃, —CMe₂Ph, —CPh₃, —SiMe₃, —SiEt₃, —SiPh₃, where Me denotes a methyl group.
R is hydrogen or an alkyl, aryl, silyl group or —OT where O is oxygen and T is hydrogen or an alkyl, aryl or silyl group.
Mⁿ is a Group 3 to 10 transition metal or a lanthanide metal, preferably a Group 4 metal, n is the valence of M and Mⁿ is also bound to Qₙ₋₁.
Q is as defined as above in Formula I or II, or Q may be any of the phenoxide groups referenced above.

The synthesis of desired ligands can be accomplished using techniques described in the literature. (See March, Jerry, Advanced Organic Chemistry, 4^{th} ed 1992, John Wiley and Sons, Inc., pp. 896-898.) For example, N-benzylidene-2-hydroxybenzylamines can be prepared by condensation of an aldehyde or ketone with 2-hydroxybenzylamine. Salicylimines can be prepared by condensation of a salicylalehyde precursor with the desired primary amine. In some instances, such as those involving less-reactive amines or aldehydes, addition of a catalytic amount of formic acid or 3 Å molecular sieves may be required. These conditions are also beneficial in the synthesis of ketimine ligands from reaction of primary amines with ortho-hydroxyketones. Phenols with heterocyclic substituents can also be prepared by standard techniques. For example, ortho-cyanophenols can be converted to oxazolines via reaction with α-aminoalcohols. Certain ligands, such as ortho-benzotriazole-substituted phenols are commercially available.

Metallation of these acidic functionalized phenols can be accomplished by reaction with basic reagents such as Zr(CH₂Ph)₄, or Ti(NMe₂)₄, where Ph denotes a phenyl group. Reaction of phenolic ligands with Zr(CH₂Ph)₄ occurs with elimination of toluene, whereas reaction with Ti(NMe₂)₄ proceeds via amine elimination. In both cases simple alkoxide complexes are formed, as determined by ¹H NMR spectroscopy. Alternatively, ligands can be deprotonated with reagents such as butyl-Li, KH or Na metal and then reacted with metal halides, such as ZrCl₄ or TiCl₄.

Preferred phenoxide transition metal compounds for use in this invention include:
bis(N-methyl-3,5-di-t-butylsalicylimino)zirconium(IV) dibenzyl;
bis(N-ethyl-3,5-di-t-butylsalicylimino)zirconium(IV) dibenzyl;
bis(N-iso-propyl-3,5-di-t-butylsalicylimino)zirconium(IV) dibenzyl;
bis(N-t-butyl-3,5-di-t-butylsalicylimino)zirconium(IV) dibenzyl;
bis(N-benzyl-3,5-di-t-butylsalicylimino)zirconium(IV) dibenzyl;
bis(N-hexyl-3,5-di-t-butylsalicylimino)zirconium(IV) dibenzyl;
bis(N-phenyl-3,5-di-t-butylsalicylimino)zirconium(IV) dibenzyl;
bis(N-methyl-3,5-di-t-butylsalicylimino)zirconium(IV) dibenzyl;
bis(N-benzyl-3,5-di-t-butylsalicylimino)zirconium(IV) dichloride;
bis(N-benzyl-3,5-di-t-butylsalicylimino)zirconium(IV) dipivalate;
bis(N-benzyl-3,5-di-t-butylsalicylimino)titanium(IV) dipivalate;
bis(N-benzyl-3,5-di-t-butylsalicylimino)zirconium(IV) di(bis(dimethylamide));
bis(N-iso-propyl-3,5-di-t-amylsalicylimino)zirconium(IV) dibenzyl;
bis(N-iso-propyl-3,5-di-t-octylsalicylimino)zirconium(IV) dibenzyl;
bis(N-iso-propyl-3,5-di-(1′,1′-dimethylbenzyl)salicylimino)zirconium(IV) dibenzyl;
bis(N-iso-propyl-3,5-di-(1′,1′-dimethylbenzyl)salicylimino)titanium(IV) dibenzyl;
bis(N-iso-propyl-3,5-di-(1′,1′-dimethylbenzyl)salicylimino)hafnium(IV) dibenzyl;
bis(N-iso-butyl-3,5-di-(1′,1′-dimethylbenzyl)salicylimino)zirconium(IV) dibenzyl;
bis(N-iso-butyl-3,5-di-(1′,1′-dimethylbenzyl)salicylimino)zirconium(IV) dichloride;
bis(N-hexyl-3,5-di-(1′,1′-dimethylbenzyl)salicylimino)zirconium(IV) dibenzyl;
bis(N-phenyl-3,5-di-(1′,1′-dimethylbenzyl)salicylimino)zirconium(IV) dibenzyl;
bis(N-iso-propyl-3,5-di-(1′-methylcyclohexyl)lsalicylimino)zirconium(IV) dibenzyl;
bis(N-benzyl-3-t-butylsalicylimino)zirconium(IV) dibenzyl;
bis(N-benzyl-3-triphenylmethylsalicylimino)zirconium(IV) dibenzyl;
bis(N-iso-propyl-3,5-di-trimethylsilylsalicylimino)zirconium(IV) dibenzyl;
bis(N-iso-propyl-3-(phenyl)salicylimino)zirconium(IV) dibenzyl;
bis(N-benzyl-3-(2′,6′-di-iso-propylphenyl)salicylimino)zirconium(IV) dibenzyl;
bis(N-benzyl-3-(2′,6′-di-phenylphenyl)salicylimino)zirconium(IV) dibenzyl;
bis(N-benzyl-3-t-butyl-5-methoxysalicylimino)zirconium(IV) dibenzyl;
bis(N-benzylidene-2-hydroxy-3,5,di-t-butylbenzylamine)zirconium(IV) dibenzyl;
bis(N-benzylidene-2-hydroxy-3,5,di-t-butylbenzylamine)zirconium(IV) dichloride;
bis(2-(2H-benzotriazol-2-yl)-4,6-di-t-amylphenoxide)zirconium(IV) dibenzyl;
bis(N-benzylidene-2-hydroxy-3,5,di-t-butylbenzylamine)titanium(IV) dibenzyl;
bis(2-(2H-benzotriazol-2-yl)-4,6-di-t-amylphenoxide)zirconium(IV) dibenzyl;
bis(2-(2H-benzotriazol-2-yl)-4,6-di-t-amylphenoxide)zirconium(IV) dichloride;
bis(2-(2H-benzotriazol-2-yl)-4,6-di-t-amylphenoxide)zirconium(IV) di(bis(dimethylamide));
bis(2-(2H-benzotriazol-2-yl)-4,6-di-(1′,1′-dimethylbenzyl)phenoxide)zirconium(IV) dibenzyl;
bis(2-(2H-benzotriazol-2-yl)-4,6-di-t-amylphenoxide)titanium(IV) dibenzyl;
bis(2-(2H-benzotriazol-2-yl)-4,6-di-(1′,1′-dimethylbenzyl)phenoxide)titanium(IV) dibenzyl;
bis(2-(2H-benzotriazol-2-yl)-4,6-di-(1′,1′-dimethylbenzyl)phenoxide)titanium(IV) dichloride;
bis(2-(2H-benzotriazol-2-yl)-4,6-di-(1′,1′-dimethylbenzyl)phenoxide)hafnium(IV) dibenzyl;
(N-phenyl-3,5-di-(1′,1′-dimethylbenzyl)salicylimino)zirconium(IV) tribenzyl;
(N-(2′,6′-di-iso-propylphenyl)-3,5-di-(1′,1′-dimethylbenzyl)salicylimino)zirconium(IV) tribenzyl;
(N-(2′,6′-di-iso-propylphenyl)-3,5-di-(1′,1′-dimethylbenzyl)salicylimino)titanium(IV) tribenzyl;
(N-(2′,6′-di-iso-propylphenyl)-3,5-di-(1′,1′-dimethylbenzyl)salicylimino)zirconium(IV) trichloride;
bis(4,6-di-t-butyl-2-benzyliminophenoxy)zirconium(IV) dibenzyl; and
bis(4,6-di-t-butyl-2-isobutlyiminophenoxy)zirconium(IV) dibenzyl.
   Activator and Activation Methods

The above described phenoxide transition metal catalysts compounds are typically activated in various ways to yield catalyst compounds having a vacant coordination site that will coordinate, insert, and polymerize olefin(s).

The preferred activator is a Lewis acid compound, more preferably an aluminum or boron based Lewis acid compound, and most preferably a neutral, aluminum based Lewis acid compound having at least one, preferably two, halogenated aryl ligands and one or two additional monoanionic ligands not including the halogenated aryl ligands.

The Lewis acid compounds of the invention include those olefin catalyst activator Lewis acids based on aluminum and having at least one bulky, electron-withdrawing ancillary ligand such as the halogenated aryl ligands of tris(perfluorophenyl)borane or tris(perfluoronaphthyl)borane. These bulky ancillary ligands are those sufficient to allow the Lewis acids to function as electronically stabilizing, compatible non-cordinating anions. Stable ionic complexes are achieved when the anions will not be a suitable ligand donor to the strongly Lewis acidic cationic heteroatom substituted phenoxide ligated Group 3 to 10 transition metal or lanthanide metal cations used in insertion polymerization, i.e., inhibit ligand transfer that would neutralize the cations and render them inactive for polymerization.

The aluminum containing Lewis acids fitting this description may be described by the following formula:
Al(R)ₙ (III)
where each R is independently a monoanionic ligand, an alkyl group, or represented by the formula ArHal, where ArHal a halogenated C₆ aromatic or higher carbon number polycyclic aromatic hydrocarbon or aromatic ring assembly in which two or more rings (or fused ring systems) are joined directly to one another or together, and n is an integer, preferably n=3.

In one embodiment, at least one R is an ArHal which is a halogenated C₉ aromatic or higher, preferably a fluorinated naphtyl. Suitable non-limiting R ligands include: substituted or unsubstituted C₁ to C₃₀ hydrocarbyl aliphatic or aromatic groups, substituted meaning that at least one hydrogen on a carbon atom is replaced with a hydrocarbyl, halide, halocarbyl, hydrocarbyl or halocarbyl substituted organometalloid, dialkylamido, alkoxy, siloxy, aryloxy, alkysulfido, arylsulfido, alkylphosphido, alkylphosphido or other anionic substituent; fluoride; bulky alkoxides, where bulky refers to C₄ and higher number hydrocarbyl groups, e.g., up to about C₂₀, such as tert-butoxide and 2,6-dimethyl-phenoxide, and 2,6-di(tert-butyl)phenoxide; —SR; —NR₂, and —PR₂, where each R is independently a substituted or unsubstituted hydrocarbyl as defined above; and, C₁ to C₃₀ hydrocarbyl substituted organometalloid, such as trimethylsilyl.

An alkyl group for purposes of this specification may be a linear, branched alkyl radicals, or alkenyl radicals, alkynyl radicals, cycloalkyl radicals or aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, aroylamino radicals, straight, branched or cyclic, alkylene radicals, or combinations thereof.

Examples of ArHal include the phenyl, napthyl and anthracenyl radicals of U.S. Pat. No. 5,198,401 and the biphenyl radicals of WO 97/29845 when halogenated, both incorporated herein by reference. The use of the terms halogenated or halogenation, for purposes of this application mean that at least one third of hydrogen atoms on carbon atoms of the aryl-substituted aromatic ligands are replaced by halogen atoms. More preferably, the aromatic ligands are perhalogenated, where the preferred halogen is fluorine.

In one embodiment, one R of formula III is an alkyl and the remaining R's of formula III are ArHal. In another embodiment, all R's of formula III above are ArHal.

Other activators or methods of activation are contemplated for use with the Lewis acid activators described above. For example other activators include: alumoxane, modified alumoxane, tri(n-butyl)ammonium tetrakis(pentafluorophenyl)boron, a trisperfluorophenyl boron metalloid precursor or a trisperfluoronaphtyl boron metalloid precursor, polyhalogenated heteroborane anions, trimethylaluminum, triethylaluminum, triisobutylaluminum, tri-n-hexylaluminum, tri-n-octylaluminum, tris(2,2′,2″-nona-fluorobiphenyl) fluoroaluminate, perchlorates, periodates, iodates and hydrates, (2,2′-bisphenyl-ditrimethylsilicate).4THF and organo-boron-aluminum compound, silylium salts and dioctadecylmethylammonium-bis(tris(pentafluorophenyl)borane)-benzimidazolide.

It is further contemplated by the invention that other catalysts including bulky ligand metallocene catalyst compounds and/or conventional catalyst compounds can be combined with the phenoxide transition metal catalysts compounds of this invention.

Supports, Carriers and General Supporting Techniques

The above described catalyst systems of a phenoxide transition metal catalysts compound and a Lewis acid containing activator may be combined with one or more support materials or carriers using one of the support methods well known in the art or as described below. For example, in a most preferred embodiment, a phenoxide transition metal catalysts compound and Lewis acid activator is in a supported form, for example deposited on, contacted with, vaporized with, bonded to, or incorporated within, adsorbed or absorbed in, or on, a support or carrier.

In one embodiment, the aluminum of formula (III) above, may be covalently bonded to a support material, preferably a metal/metalloid oxide or polymeric support. In another embodiment, the Lewis base-containing support materials or substrates will react with the Lewis acid activators to form a support bonded Lewis acid compound, a supported activator, where the aluminum of Al(R)ₙ, described above, is covalently bonded to the support material. For example, where the support material is silica, the Lewis base hydroxyl groups of the silica is where this method of bonding at one of the aluminum coordination sites occurs. Generally, the supported Lewis acid activator is represented by the formula:
(Sup-E-)ₙAl(R)₄₋ₙ (IV)
where Sup-E is a Lewis base containing support material or substrate. Preferably Sup is any suitable material or substrate that contains surface hydroxyl groups, such as for example, silica or an hydroxyl group-containing polymeric support. E is a Group 16 atom, preferably oxygen; R is defined above; and n is an integer, preferably n is 1, 2 or 3.

In another embodiment, the support material is a metal or metalloid oxide, preferably having surface hydroxyl groups exhibiting a pKₐ equal to or less than that observed for amorphous silica, i.e., pKₐ less than or equal to about 11.

In another embodiment, trisperfluorophenyl boron may react with silanol groups (the hydroxyl groups of silicon) resulting in bound anions capable of protonating transition metal organometallic catalyst compounds to form catalytically active cations counter-balanced by the bound anions as described in U.S. Pat. No. 5,643,847 incorporated herein by reference.

While not wishing to be bound to any particular theory, it is believed that the covalently bound anionic activator, the Lewis acid, is believed to form initially a dative complex with a silanol group, for example of silica (which acts as a Lewis base), thus forming a formally dipolar (zwitterionic) Bronsted acid structure bound to the metal/metalloid of the metal oxide support. Thereafter, the proton of the Bronsted acid appears to protonate an R-group of the Lewis acid, abstracting it, at which time the Lewis acid becomes covalently bonded to the oxygen atom. The replacement R group of the Lewis acid then becomes Sup-E-, where Sup is a suitable support material or substrate, for example, silica or hydroxyl group-containing polymeric support. Any support material that contain surface hydroxyl groups are suitable for use in this particular supporting method.

In one embodiment where the support material is a metal oxide composition, these compositions may additionally contain oxides of other metals, such as those of Al, K, Mg, Na, Si, Ti and Zr and should preferably be treated by thermal and/or chemical means to remove water and free oxygen. Typically such treatment is in a vacuum in a heated oven, in a heated fluidized bed or with dehydrating agents such as organo silanes, siloxanes, alkyl aluminum compounds, etc. The level of treatment should be such that as much retained moisture and oxygen as is possible is removed, but that a chemically significant amount of hydroxyl functionality is retained. Thus calcining at up to 800° C. or more up to a point prior to decomposition of the support material, for several hours is permissible, and if higher loading of supported anionic activator is desired, lower calcining temperatures for lesser times will be suitable. Where the metal oxide is silica, loadings to achieve from less than 0.1 mmol to 3.0 mmol activator/g SiO₂ are typically suitable and can be achieved, for example, by varying the temperature of calcining from 200 to 800+° C. See Zhuralev, et al, Langmuir 1987, Vol. 3, 316 where correlation between calcining temperature and times and hydroxyl contents of silica's of varying surface areas is described.

The tailoring of hydroxyl groups available as attachment sites can also be accomplished by the pre-treatment, prior to addition of the Lewis acid, with a less than stoichiometric amount of the chemical dehydrating agents. Preferably any such dehydrating agent will be used sparingly and will have a single ligand reactive with the silanol groups (e.g., (CH₃)₃SiCl), or otherwise hydrolyzable, so as to minimize interference with the reaction of the transition metal catalyst compounds with the bound activator. If calcining temperatures below 400° C. are employed, difunctional coupling agents (e.g., (CH₃)₂SiCl₂) may be employed to cap hydrogen bonded pairs of silanol groups which are present under the less severe calcining conditions. See for example, “Investigation of Quantitative SiOH Determination by the Silane Treatment of Disperse Silica”, Gorski, et al, Journ. of Colloid and Interface Science, Vol. 126, No. 2, December 1988, for discussion of the effect of silane coupling agents for silica polymeric fillers that will also be effective for modification of silanol groups on the catalyst supports of this invention. Similarly, use of the Lewis acid in excess of the stoichiometric amount needed for reaction with the transition metal compounds will serve to neutralize excess silanol groups without significant detrimental effect for catalyst preparation or subsequent polymerization.

Polymeric supports are preferably hydroxyl-functional-group-containing polymeric substrates, but functional groups may be any of the primary alkyl amines, secondary alkyl amines, and others, where the groups are structurally incorporated in a polymeric chain and capable of a acid-base reaction with the Lewis acid such that a ligand filling one coordination site of the aluminum is protonated and replaced by the polymer incorporated functionality. See, for example, the functional group containing polymers of U.S. Pat. No. 5,288,677, which is herein incorporated by reference.

Other supports include silica, alumina, silica-alumina, magnesia, titania, zirconia, magnesium chloride, montmorillonite, phyllosilicate, zeolites, talc, clays, silica-chromium, silica-alumina, silica-titania, porous acrylic polymers.

In one embodiment, the support material or carrier, most preferably an inorganic oxide has a surface area in the range of from about 10 to about 100 m²/g, pore volume in the range of from about 0.1 to about 4.0 cc/g and average particle size in the range of from about 5 to about 500 μm. More preferably, the surface area of the carrier is in the range of from about 50 to about 500 m²/g, pore volume of from about 0.5 to about 3.5 cc/g and average particle size of from about 10 to about 200 μm. Most preferably the surface area of the carrier is in the range is from about 100 to about 400 m²/g, pore volume from about 0.8 to about 5.0 cc/g and average particle size is from about 5 to about 100 μm. The average pore size of the carrier of the invention typically has pore size in the range of from 10 to 1000 Å, preferably 50 to about 500 Å, and most preferably 75 to about 450 Å.

There are various other methods in the art for supporting a polymerization catalyst compound or catalyst system of the invention.

In another embodiment, the invention provides for a phenoxide transition metal catalyst system which includes a surface modifier that is used in the preparation of the supported catalyst system as described in PCT publication WO 96/11960, which is herein fully incorporated by reference. The catalyst systems of the invention can be prepared in the presence of an olefin, for example hexene-1.

In another embodiment, the phenoxide transition metal catalyst system can be combined with a carboxylic acid salt of a metal ester, for example aluminum carboxylates such as aluminum mono, di- and tri-stearates, aluminum octoates, oleates and cyclohexylbutyrates, as described in U.S. application Ser. No. 09/113,216, filed Jul. 10, 1998 incorporated herein by reference.

In another embodiment, a method for producing a supported phenoxide transition metal catalyst system is described below and is described in U.S. application Ser. Nos. 265,533, filed Jun. 24, 1994 and 265,532, filed Jun. 24, 1994, and PCT publications WO 96/00245 and WO 96/00243 both published Jan. 4, 1996, all of which are herein fully incorporated by reference. In this method, the phenoxide transition metal catalyst compound is slurried in a liquid to form a solution and a separate solution is formed containing a Lewis acid activator and a liquid. The liquid may be any compatible solvent or other liquid capable of forming a solution or the like with the phenoxide transition metal catalyst compounds and/or Lewis acid activator. In a preferred embodiment the liquid is a cyclic aliphatic or aromatic hydrocarbon, for example, toluene. The phenoxide transition metal catalyst compounds and Lewis acid activator solutions are mixed together and added to a porous support such that the total volume of phenoxide transition metal catalyst compound solution and the Lewis acid activator solution is less than four times the pore volume of the porous support, more preferably less than three times, even more preferably less than two times; preferred ranges being from 1.1 times to 3.5 times range and most preferably in the 1.2 to 3 times range.

Procedures for measuring the total pore volume of a porous support are well known in the art. Details of one of these procedures is discussed in Volume 1, Experimental Methods in Catalytic Research (Academic Press, 1968) (specifically see pages 67-96). This preferred procedure involves the use of a classical BET apparatus for nitrogen absorption. Another method well known in the art is described in Innes, Total Porosity and Particle Density of Fluid Catalysts By Liquid Titration, Vol. 28, No. 3, Analytical Chemistry 332-334 (March, 1956).

The mole ratio of the metal of the activator component to the metal component of the phenoxide transition metal catalyst compound is preferably in the range of between 0.3:1 to 3:1.

In one embodiment of the invention, olefin(s), preferably C₂ to C₃₀ olefin(s) or alpha-olefin(s), preferably ethylene or propylene or combinations thereof are prepolymerized in the presence of the catalyst system of the invention prior to the main polymerization. The prepolymerization can be carried out batchwise or continuously in gas, solution or slurry phase including at elevated pressures. The prepolymerization can take place with any olefin monomer or combination and/or in the presence of any molecular weight controlling agent such as hydrogen. For examples of prepolymerization procedures, see U.S. Pat. Nos. 4,748,221, 4,789,359, 4,923,833, 4,921,825, 5,283,278 and 5,705,578 and European publication EP-B-0279 863 and PCT Publication WO 97/44371 all of which are herein fully incorporated by reference.

Polymerization Process

The catalyst systems, supported catalyst systems or compositions of the invention described above are suitable for use in any prepolymerization and/or polymerization process over a wide range of temperatures and pressures. The temperatures may be in the range of from −60° C. to about 280° C., preferably from 50° C. to about 200° C., and the pressures employed may be in the range from 1 atmosphere to about 500 atmospheres or higher.

Polymerization processes include solution, gas phase, slurry phase and a high pressure process or a combination thereof. Particularly preferred is a gas phase or slurry phase polymerization of one or more olefins at least one of which is ethylene or propylene.

In one embodiment, the process of this invention is directed toward a solution, high pressure, slurry or gas phase polymerization process of one or more olefin monomers having from 2 to 30 carbon atoms, preferably 2 to 12 carbon atoms, and more preferably 2 to 8 carbon atoms. The invention is particularly well suited to the polymerization of two or more olefin monomers of ethylene, propylene, butene-1, pentene-1, 4-methyl-pentene-1, hexene-1, octene-1 and decene-1.

Other monomers useful in the process of the invention include ethylenically unsaturated monomers, diolefins having 4 to 18 carbon atoms, conjugated or nonconjugated dienes, polyenes, vinyl monomers and cyclic olefins. Non-limiting monomers useful in the invention may include norbornene, norbornadiene, isobutylene, isoprene, vinylbenzocyclobutane, styrenes, alkyl substituted styrene, ethylidene norbornene, dicyclopentadiene and cyclopentene.

In the most preferred embodiment of the process of the invention, a copolymer of ethylene is produced, where with ethylene, a comonomer having at least one alpha-olefin having from 4 to 15 carbon atoms, preferably from 4 to 12 carbon atoms, and most preferably from 4 to 8 carbon atoms, is polymerized in a gas phase process.

In another embodiment of the process of the invention, ethylene or propylene is polymerized with at least two different comonomers, optionally one of which may be a diene, to form a terpolymer.

In one embodiment, the invention is directed to a polymerization process, particularly a gas phase or slurry phase process, for polymerizing propylene alone or with one or more other monomers including ethylene, and/or other olefins having from 4 to 12 carbon atoms.

Typically in a gas phase polymerization process a continuous cycle is employed where in one part of the cycle of a reactor system, a cycling gas stream, otherwise known as a recycle stream or fluidizing medium, is heated in the reactor by the heat of polymerization. This heat is removed from the recycle composition in another part of the cycle by a cooling system external to the reactor. Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See for example U.S. Pat. Nos. 4,543,399, 4,588,790, 5,028,670, 5,317,036, 5,352,749, 5,405,922, 5,436,304, 5,453,471, 5,462,999, 5,616,661 and 5,668,228, all of which are fully incorporated herein by reference.)

The reactor pressure in a gas phase process may vary from about 100 psig (690 kPa) to about 500 psig (3448 kPa), preferably in the range of from about 200 psig (1379 kPa) to about 400 psig (2759 kPa), more preferably in the range of from about 250 psig (1724 kPa) to about 350 psig (2414 kPa).

The reactor temperature in a gas phase process may vary from about 30° C. to about 120° C., preferably from about 60° C. to about 115° C., more preferably in the range of from about 70° C. to 110° C., and most preferably in the range of from about 70° C. to about 95° C.

Other gas phase processes contemplated by the process of the invention include series or multistage polymerization processes. Also gas phase processes contemplated by the invention include those described in U.S. Pat. Nos. 5,627,242, 5,665,818 and 5,677,375, and European publications EP-A-0 794 200 EP-B1-0 649 992, EP-A-0 802 202 and EP-B-634 421 all of which are herein fully incorporated by reference.

In a preferred embodiment, the reactor utilized in the present invention is capable and the process of the invention is producing greater than 500 lbs of polymer per hour (227 Kg/hr) to about 200,000 lbs/hr (90,900 Kg/hr) or higher of polymer, preferably greater than 1000 lbs/hr (455 Kg/hr), more preferably greater than 10,000 lbs/hr (4540 Kg/hr), even more preferably greater than 25,000 lbs/hr (11,300 Kg/hr), still more preferably greater than 35,000 lbs/hr (15,900 Kg/hr), still even more preferably greater than 50,000 lbs/hr (22,700 Kg/hr) and most preferably greater than 65,000 lbs/hr (29,000 Kg/hr) to greater than 100,000 lbs/hr (45,500 Kg/hr).

A slurry polymerization process generally uses pressures in the range of from about 1 to about 50 atmospheres and even greater and temperatures in the range of 0° C. to about 120° C. In a slurry polymerization, a suspension of solid, particulate polymer is formed in a liquid polymerization diluent medium to which ethylene and comonomers and often hydrogen along with catalyst are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used the process must be operated above the reaction diluent critical temperature and pressure. Preferably, a hexane or an isobutane medium is employed.

A preferred polymerization technique of the invention is referred to as a particle form polymerization, or a slurry process where the temperature is kept below the temperature at which the polymer goes into solution. Such technique is well known in the art, and described in for instance U.S. Pat. No. 3,248,179 which is fully incorporated herein by reference. Other slurry processes include those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484, which is herein fully incorporated by reference.

In an embodiment the reactor used in the slurry process of the invention is capable of and the process of the invention is producing greater than 2000 lbs of polymer per hour (907 Kg/hr), more preferably greater than 5000 lbs/hr (2268 Kg/hr), and most preferably greater than 10,000 lbs/hr (4540 Kg/hr). In another embodiment the slurry reactor used in the process of the invention is producing greater than 15,000 lbs of polymer per hour (6804 Kg/hr), preferably greater than 25,000 lbs/hr (11,340 Kg/hr) to about 100,000 lbs/hr (45,500 Kg/hr).

Examples of solution processes are described in U.S. Pat. Nos. 4,271,060, 5,001,205, 5,236,998 and 5,589,555 and PCT WO 99/32525, which are fully incorporated herein by reference.

In one embodiment of the process of the invention is the process, preferably a slurry or gas phase process is operated in the presence of the catalyst system of the invention and in the absence of or essentially free of any scavengers, such as triethylaluminum, trimethylaluminum, tri-isobutylaluminum and tri-n-hexylaluminum and diethyl aluminum chloride, dibutyl zinc and the like. This process is described in PCT publication WO 96/08520 and U.S. Pat. No. 5,712,352 and 5,763,543, which are herein fully incorporated by reference.

Polymer Products

The polymers produced by the process of the invention can be used in a wide variety of products and end-use applications. The polymers produced by the process of the invention include linear low density polyethylene, elastomers, plastomers, high density polyethylenes, medium density polyethylenes, low density polyethylenes, polypropylene and polypropylene copolymers.

The polymers, typically ethylene based polymers, have a density in the range of from 0.86 g/cc to 0.97 g/cc, preferably in the range of from 0.88 g/cc to 0.965 g/cc, more preferably in the range of from 0.900 g/cc to 0.96 g/cc, even more preferably in the range of from 0.905 g/cc to 0.95 g/cc, yet even more preferably in the range from 0.910 g/cc to 0.940 g/cc, and most preferably greater than 0.915 g/cc, preferably greater than 0.920 g/cc, and most preferably greater than 0.925 g/cc. Density is measured in accordance with ASTM-D-1238.

The polymers produced by the process of the invention typically have a molecular weight distribution, a weight average molecular weight to number average molecular weight (M_{w}/Mₙ) of greater than 1.5 to about 15, particularly greater than 2 to about 10, more preferably greater than about 2.2 to less than about 8, and most preferably from 2.5 to 8.

Also, the polymers of the invention typically have a narrow composition distribution as measured by Composition Distribution Breadth Index (CDBI). Further details of determining the CDBI of a copolymer are known to those skilled in the art. See, for example, PCT Patent Application WO 93/03093, published Feb. 18, 1993, which is fully incorporated herein by reference.

The polymers of the invention in one embodiment have CDBI's generally in the range of greater than 50% to 100%, preferably 99%, preferably in the range of 55% to 85%, and more preferably 60% to 80%, even more preferably greater than 60%, still even more preferably greater than 65%.

In another embodiment, polymers produced using a catalyst system of the invention have a CDBI less than 50%, more preferably less than 40%, and most preferably less than 30%.

The polymers of the present invention in one embodiment have a melt index (MI) or (I₂) as measured by ASTM-D-1238-E in the range from no measurable flow to 1000 dg/min, more preferably from about 0.01 dg/min to about 100 dg/min, even more preferably from about 0.1 dg/min to about 50 dg/min, and most preferably from about 0.1 dg/min to about 10 dg/min.

The polymers of the invention in an embodiment have a melt index ratio (I₂₁/I₂) (I₂₁ is measured by ASTM-D-1 238-F) of from 10 to less than 25, more preferably from about 15 to less than 25.

The polymers of the invention in a preferred embodiment have a melt index ratio (I₂₁/I₂) (I₂₁ is measured by ASTM-D-1238-F) of from preferably greater than 25, more preferably greater than 30, even more preferably greater that 40, still even more preferably greater than 50 and most preferably greater than 65. In an embodiment, the polymer of the invention may have a narrow molecular weight distribution and a broad composition distribution or vice-versa, and may be those polymers described in U.S. Pat. No. 5,798,427 incorporated herein by reference.

In yet another embodiment, propylene based polymers are produced in the process of the invention. These polymers include atactic polypropylene, isotactic polypropylene, hemi-isotactic and syndiotactic polypropylene. Other propylene polymers include propylene block or impact copolymers. Propylene polymers of these types are well known in the art see for example U.S. Pat. Nos. 4,794,096, 3,248,455, 4,376,851, 5,036,034 and 5,459,117, all of which are herein incorporated by reference.

The polymers of the invention may be blended and/or coextruded with any other polymer. Non-limiting examples of other polymers include linear low density polyethylenes, elastomers, plastomers, high pressure low density polyethylene, high density polyethylenes, polypropylenes and the like.

Polymers produced by the process of the invention and blends thereof are useful in such forming operations as film, sheet, and fiber extrusion and co-extrusion as well as blow molding, injection molding and rotary molding. Films include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, membranes, etc. in food-contact and non-food contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

### EXAMPLES

In order to provide a better understanding of the present invention including representative advantages thereof, the following examples are offered.

The imino-phenoxide catalysts utilized in these examples appear below.

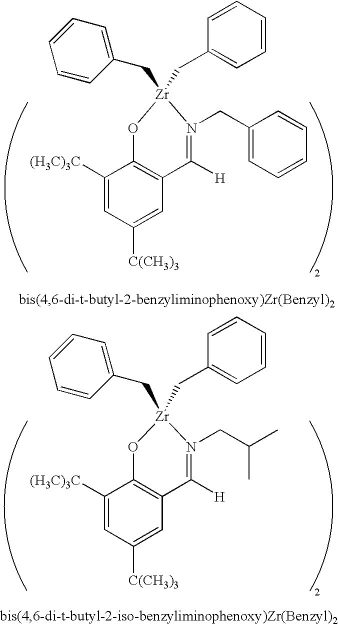

The imino-phenoxide catalysts may be prepared by methods known in the art. For example the ligand iso-butyl-imino-3,5-di-t-butylphenol could be prepared by combining the 3,5-di-t-butyl-2-hydroxybenzaldehyde and isobutylamine in a suitable solvent, for example pentane, stirring for about an hour then drying over MgSO₄. The ligand could then be combined with Zr(Bz)₄, where Bz denotes a benzene group, in a suitable solvent, preferably toluene. After mixing for about 1 hour the toluene may be removed in vacuuo and pentane added. After mixing for several minutes, the product may then be filtered and collected.

Synthesis of Al(C₆F₅)₃.toluene was in accordance with the method described in EP 0 694 548 A1, which is fully incorporated by reference.

To synthesize the silica bound aluminum (Si—O—Al(C₆F₅)₂), a sample of 40.686 g of silica (Davison 948, calcined at 600° C., available from W. R. Grace, Davison Division, Baltimore, Md.) was pre-dried and reacted with a slight excess of (C₆F₅)₃A1 in order to remove residual reactive Si—OH moieties. This pretreated silica was slurried in 300 mL of toluene in a 500 mL round bottom flask. Solid Al(C₆F₅)₃.toluene (15.470 g, 24.90 mmol) was added and the mixture stirred for 30 minutes. The mixture was allowed to stand for 18 hours. The silica bound aluminum was isolated by filtration and dried for 6 hours under vacuum with a yield of 49.211 g.

All polymerizations were performed in a 2.2L Autoclave Engineers Zipperclave reactor. The ethylene feed was passed through a 1L Labclear purification bed and a 1L 3-4 Å molecular sieve bed. The isobutane diluent was fed from 5 gallon (18.9 liter) tanks and passed through a 2.2L Labclear purification bed. Pre-purified hexene was filtered through activated alumina. All catalyst preps were preformed in a nitrogen purged drybox.

The polymerization technique utilized A 2.2 L zipperclave reactor charged with 1.4 mL of a 25wt % hexane solution of tri-n-octylaluminum (TNOA), hexene, if utilized, was added via syringe, then the reactor was charged with 440 g of isobutane. Optionally, a small amount of ethylene could be added to the isobutane charge. The catalyst was injected into the reactor with nitrogen, and the reactor was brought to temperature (about 60 to 90° C.) with stirring. When the temperature stabilized data collection began with ethylene supply to the reactor at 125 psi (862 kPa) over solvent pressure. Standard run time was 30 minutes. The reactor was vented, flushed with nitrogen, and then opened to collect the polymer product.

The reaction temperature, pressure, yield and activity as well as the I₂ and I₂₁ of each polymer product are summarized in Table 1 (where I₂ is the melt index (MI) measured according to ASTM D-1238, Condition E, at 190° C., and where I₂₁ is the flow index (FI) measured according to ASTM D-1238, Condition F, at 190° C.).

### Example 1

Bis(4,6-di-t-butyl-2-benzyliminophenoxy)Zr(Benzyl)₂ (0.42 g) was dissolved in 5 ml toluene. The treated silica (1 g), prepared above, was added. The mixture was stirred for 10 minutes, then filtered. The resulting catalyst product, dark yellow solids, were dried in vacuo. Polymerization of ethylene with 0.10 g of this catalyst product yielded 21.7 g of polyethylene.

### Example 2

Bis(4,6-di-t-butyl-2-iso-butyliminophenoxy)Zr(Benzyl)₂ (0.39 g) was dissolved in 5 ml toluene. The treated silica (1 g), prepared above, was added. The mixture was stirred for 10 minutes, then filtered. The resulting catalyst product, yellow solids, were dried in vacuo. Example 2a—Polymerization of ethylene with 0.10 g of this catalyst product yielded 26.6 g of polyethylene. Example 2b—Polymerization of ethylene performed with a 5 ml charge of hexene, using 0.10 g of the product, yielded 38.4 g of polymer.

### Example 3

Bis(4,6-di-t-butyl-2-benzyliminophenoxy)Zr(Benzyl)₂ (0.27 g) was dissolved in 5 ml toluene with dimethylsilyl(n-propylcyclopentadieneyl)₂ZrMe₂ (0.10 g). The treated silica (1 g), prepared above, was added. The mixture was stirred for 10 minutes, then filtered. The resulting catalyst product, yellow solids, were dried in vacuo. Example 3a—Polymerization of ethylene with 0.10 g of this catalyst product yielded 87 g of polyethylene. Example 3b—Polymerization of ethylene performed with a 25 ml charge of hexene, using 0.10 g of the product, yielded 108 g of polymer.

### Example 4

Bis(4,6-di-t-butyl-2-iso-butyliminophenoxy)Zr(Benzyl)₂ (0.26 g) was dissolved in 5 ml toluene with (N,N″-dimesityl-diethylenetriamine)Hf(Benzyl)₂ (0.16 g). The treated silica (1 g), prepared above, was added. The mixture was stirred for 10 minutes, then filtered. The resulting catalyst product, yellow solids, were dried in vacuo. Example 4a—Polymerization of ethylene with 0.10 g of this catalust product yielded 65 g of polyethylene. Example 4b—Polymerization of ethylene performed with a 25 ml charge of hexene, using 0.10 g of the product, yielded 142 g of polymer.

TABLE 1

| | Average | Average | Poly- | Specific | Melt | Flow |
|---|---|---|---|---|---|---|
| | Run | Run | mer | Activity | Index | Index |
| Example | Temp. | Pressure | Yield | g/mmol · | I₂ | I₂₁ |
| Number | ° C. | psi (kPa) | g | atm · h | dg/min | dg/min |
| 1 | 90 | 383 (2641) | 21.7 | 159 | *NF | 1.0 |
| 2a | 90 | 383 (2641) | 26.6 | 185 | *TR | TR |
| 2b | 90 | 382 (2634) | 38.4 | 281 | TR | TR |
| 3a | 90 | 381 (2627) | 87.1 | 516 | 0.2 | 40 |
| 3b | 90 | 380 (2620) | 108 | 705 | 0.5 | 66 |
| 4a | 90 | 382 (2634) | 65.2 | 407 | NF | 20 |
| 4b | 90 | 379 (2613) | 142 | 932 | 1.0 | 176 |

*NF indicated the sample did not flow under test conditions
*TR indicates the polymer flows too rapidly to be measured

While the present invention has been described and illustrated by reference to particular embodiments, those of ordinary skill in the art will appreciate that the invention lends itself to variations not necessarily illustrated herein. For example, it is contemplated that two or more supported a phenoxide transition metal compound catalyst compositions of the invention can be used in a single or in multiple polymerization reactor configurations. For this reason, then, reference should be made solely to the appended claims for purposes of determining the true scope of the present invention.

1. A process for polymerizing olefin(s) in the presence of a catalyst system comprising a phenoxide transition metal catalyst compound and a Lewis acid aluminum containing activator, wherein the phenoxide transition metal catalyst compound comprises one or more heteroatom substituted phenoxide ligated Group 3 to 10 transition metal or lanthanide metal compounds, and wherein the Group 3 to 10 transition metal or lanthanide metal of the phenoxide transition metal catalyst compound is bound to the oxygen of the phenoxide group.

2. The process of claim 1 wherein the Lewis acid aluminum containing activator is represented by the formula:
AlRₙ
where each R is independently a monoanionic ligand, an alkyl group, or represented by the formula ArHal, where ArHal is a halogenated C₆ aromatic or higher carbon number polycyclic aromatic hydrocarbon or aromatic ring assembly in which two or more rings or fused ring systems are joined directly to one another or together, and n is an integer.

3. The process of claim 2 wherein the Lewis acid aluminum containing activator is covalently bonded to a support material.

4. The process of claim 3 wherein the support material contains a functional group selected from the group consisting of hydroxyl, primary alkyl amines, secondary alkyl amines, and combinations thereof.

5. The process of claim 1 wherein the Lewis acid aluminum containing activator is bound to the support material and represented by the formula:
(Sup-E-)ₙAl(R)₄₋ₙ
where Sup-E is a Lewis base containing support material or substrate; each R is independently a monoanionic ligand, an alkyl group, or represented by the formula ArHal, where ArHal is a halogenated C₆ aromatic or higher carbon number polycyclic aromatic hydrocarbon or aromatic ring assembly in which two or more rings (or fused ring systems) are joined directly to one another or together; and n is an integer.

6. The process of claim 2 further comprising another activator selected from the group consisting of alumoxane, modified alumoxane, tri (n-butyl) ammonium tetrakis (pentafluorophenyl) boron, a trisperfluorophenyl boron metalloid precursor, a trisperfluoronaphtyl boron metalloid precursor, polyhalogenated heteroborane anions, trimethylaluminum, triethylaluminum, triisobutylaluminum, tri-n-hexylaluminum, tri-n-octylaluminum, tris (2,2′,2″-nona-fluorobiphenyl) fluoroaluminate, perchlorates, periodates, iodates and hydrates, (2,2′-bisphenyl-ditrimethylsilicate).4THF, organo-boron-aluminum compound, silylium salts, dioctadecylmethylammonium-bis(tris(pentafluorophenyl)borane)-benzimidazolide, and combinations thereof.

7. The process of claim 2 wherein the metal component of the Lewis acid aluminum containing activator and the metal component of the phenoxide transition metal catalyst compound are combined in a mole ratio of from about 0.3:1 to about 3:1 respectively.

8. The process of claim 1 wherein the one or more heteroatom substituted phenoxide transition metal compounds may be represented by the following formulae: 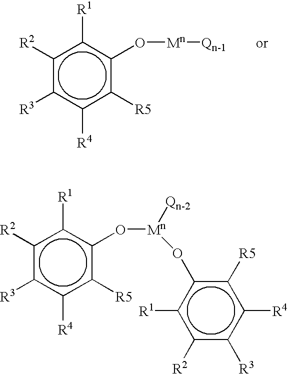
wherein R¹ to R⁵ may be independently hydrogen, a heteroatom containing group or a C₁ to C₁₀₀ group provided that at least one of R² to R⁵ is a group containing a heteroatom, any of R¹ to R⁵ may or may not be bound to the metal M;
O is oxygen;
M is a Group 3 to 10 transition metal or a lanthanide metal,
n is the valence state of M; and
Q is an anionic ligand or a bond to an R group containing a heteroatom which may be any of R¹ to R⁵.

9. The process of claim 8 wherein M is a Group 4 metal.

10. The process of claim 8 wherein the heteroatom substituted phenoxide transition metal compound is selected from the group consisting of:
bis(N-benzylidene-2-hydroxy-3,5,di-t-butylbenzylamine)zirconium(IV) dibenzyl;
bis(N-benzylidene-2-hydroxy-3,5,di-t-butylbenzylamine)zirconium(IV) dichloride;
bis(2-(2H-benzotriazol-2-yl)-4,6-di-t-amylphenoxide)zirconium(IV) dibenzyl;
bis(N-benzylidene-2-hydroxy-3,5,di-t-butylbenzylamine)titanium(IV) dibenzyl;
bis(2-(2H-benzotriazol-2-yl)-4,6-di-t-amylphenoxide)zirconium(IV) dibenzyl;
bis(2-(2H-benzotriazol-2-yl)-4,6-di-t-amylphenoxide)zirconium(IV) dichloride;
bis(2-(2H-benzotriazol-2-yl)-4,6-di-t-amylphenoxide)zirconium(IV) di(bis(dimethylamide));
bis(2-(2H-benzotriazol-2-yl)-4,6-di-(1′,1′-dimethylbenzyl)phenoxide)zirconium(IV) dibenzyl;
bis(2-(2H-benzotriazol-2-yl)-4,6-di-t-amylphenoxide)titanium(IV) dibenzyl;
bis(2-(2H-benzotriazol-2-yl)-4,6-di-(1′,1′-dimethylbenzyl)phenoxide)titanium(IV) dibenzyl;
bis(2-(2H-benzotriazol-2-yl)-4,6-di-(1′,1′-dimethylbenzyl)phenoxide)titanium(IV) dichloride;
bis(2-(2H-benzotriazol-2-yl)-4,6-di-(1′,1′-dimethylbenzyl)phenoxide)hafnium(IV) dibenzyl; (N-phenyl-3,5-di-(1′,1′-dimethylbenzyl)salicylimino)zirconium(IV) tribenzyl.;
bis(4,6-di-t-butyl-2-benzyliminophenoxy)Zr(Benzyl)₂; and
bis(4,6-di-t-butyl-2-iso-butyliminophenoxy)Zr(Benzyl)_{2.}

11. The process of claim 8 wherein the heteroatom substituted phenoxide transition metal compound is selected from the group consisting of:
bis(N-methyl-3,5-di-t-butylsalicylimino)zirconium(IV) dibenzyl;
bis(N-ethyl-3,5-di-t-butylsalicylimino)zirconium(IV) dibenzyl;
bis(N-iso-propyl-3,5-di-t-butylsalicylimino)zirconium(IV) dibenzyl;
bis(N-t-butyl-3,5-di-t-butylsalicylimino)zirconium(IV) dibenzyl;
bis(N-benzyl-3,5-di-t-butylsalicylimino)zirconium(IV) dibenzyl;
bis(N-hexyl-3,5-di-t-butylsalicylimino)zirconium(IV) dibenzyl;
bis(N-phenyl-3,5-di-t-butylsalicylimino)zirconium(IV) dibenzyl;
bis(N-methyl-3,5-di-t-butylsalicylimino)zirconium(IV) dibenzyl;
bis(N-benzyl-3,5-di-t-butylsalicylimino)zirconium(IV) dichloride;
bis(N-benzyl-3,5-di-t-butylsalicylimino)zirconium(IV) dipivalate;
bis(N-benzyl-3,5-di-t-butylsalicylimino)titanium(IV) dipivalate;
bis(N-benzyl-3,5-di-t-butylsalicylimino)zirconium(IV) di(bis(dimethylamide));
bis(N-iso-propyl-3,5-di-t-amylsalicylimino)zirconium(IV) dibenzyl;
bis(N-iso-propyl-3,5-di-t-octylsalicylimino)zirconium(IV) dibenzyl;
bis(N-iso-propyl-3,5-di-(1′,1′-dimethylbenzyl)salicylimino)zirconium(IV) dibenzyl;
bis(N-iso-propyl-3,5-di-(1′,1′-dimethylbenzyl)salicylimino)titanium(IV) dibenzyl;
bis(N-iso-propyl-3,5-di-(1′,1′-dimethylbenzyl)salicylimino)hafnium(IV) dibenzyl;
bis(N-iso-butyl-3,5-di-(1′,1′-dimethylbenzyl)salicylimino)zirconium(IV) dibenzyl;
bis(N-iso-butyl-3,5-di-(1′,1′-dimethylbenzyl)salicylimino)zirconium(IV) dichloride;
bis(N-hexyl-3,5-di-(1′,1′-dimethylbenzyl)salicylimino)zirconium(IV) dibenzyl;
bis(N-phenyl-3,5-di-(1′,1′-dimethylbenzyl)salicylimino)zirconium(IV) dibenzyl;
bis(N-iso-propyl-3,5-di-(1′-methylcyclohexyl)lsalicylimino)zirconium(IV) dibenzyl;
bis(N-benzyl-3-t-butylsalicylimino)zirconium(IV) dibenzyl;
bis(N-benzyl-3-triphenylmethylsalicylimino)zirconium(IV) dibenzyl;
bis(N-iso-propyl-3,5-di-trimethylsilylsalicylimino)zirconium(IV) dibenzyl;
bis(N-iso-propyl-3-(phenyl)salicylimino)zirconium(IV) dibenzyl;
bis(N-benzyl-3-(2′,6′-di-iso-propylphenyl)salicylimino)zirconium(IV) dibenzyl;
bis(N-benzyl-3-(2′,6′-di-phenylphenyl)salicylimino)zirconium(IV) dibenzyl;
bis(N-benzyl-3-t-butyl-5-methoxysalicylimino)zirconium(IV) dibenzyl;
bis(2-(2H-benzotriazol-2-yl)-4,6-di-t-amylphenoxide)zirconium(IV) dibenzyl;
bis(2-(2H-benzotriazol-2-yl)-4,6-di-t-amylphenoxide)zirconium(IV) dichloride;
bis(2-(2H-benzotriazol-2-yl)-4,6-di-t-amylphenoxide)zirconium(IV) di(bis(dimethylamide));
bis(2-(2H-benzotriazol-2-yl)-4,6-di-(1′,1′-dimethylbenzyl)phenoxide)zirconium(IV) dibenzyl;
bis(2-(2H-benzotriazol-2-yl)-4,6-di-t-amylphenoxide)titanium(IV) dibenzyl;
bis(2-(2H-benzotriazol-2-yl)-4,6-di-(1′,1′-dimethylbenzyl)phenoxide)titanium(IV) dibenzyl;
bis(2-(2H-benzotriazol-2-yl)-4,6-di-(1′,1′-dimethylbenzyl)phenoxide)titanium(IV) dichloride;
bis(2-(2H-benzotriazol-2-yl)-4,6-di-(1′,1′-dimethylbenzyl)phenoxide)hafnium(IV) dibenzyl;
(N-phenyl-3,5-di-(1′,1′-dimethylbenzyl)salicylimino)zirconium(IV) tribenzyl
(N-(2′,6′-di-iso-propylphenyl)-3,5-di-(1′,1′-dimethylbenzyl)salicylimino)zirconium(IV) tribenzyl;
(N-(2′,6′-di-iso-propylphenyl)-3,5-di-(1′,1′-dimethylbenzyl)salicylimino)titanium(IV) tribenzyl; and
(N-(2′,6′-di-iso-propylphenyl)-3,5-di-(1′,1′-dimethylbenzyl)salicylimino)zirconium(IV) trichloride.

12. The process of claim 1 wherein the process is a continuous gas phase process.

13. The process of claim 1 wherein the process is a continuous slurry phase process.

14. The process of claim 1 wherein the olefin(s) is ethylene or propylene.

15. The process of claim 1 wherein the olefins are ethylene and at least one other monomer having from 3 to 20 carbon atoms.
